(19) United States
(12) Patent Application Publication
(10) Pub. No.: US 2007/0133592 A1
(43) Pub. Date: Jun. 14, 2007

(54) Method for tree-based spatial time division multiple access (TDMA) scheduling in a multi-hop wireless

(76) Inventors: Heyun Zheng, Debary, FL (US); Surong Zeng, Altamonte Springs, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/301,432

(22) Filed: Dec. 13, 2005

(51) Int. Cl. H04L 12/43

(52) U.S. Cl. 370/458; 370/337

(57) ABSTRACT

A method for tree based spatial TDMA scheduling in a multi-hop wireless network (100). A time slot is requested (101) for non-use by a requesting node to all neighboring nodes. Similarly, the requested time slot is next requested (103) for non-use from the requesting node to its parent nodes. If available, a time slot assignment is then requested (109) from the requesting node to its parent node where the time slot assignment is requested (111) from the parent node to the grandparent node of the requesting node. Finally, all neighboring nodes are then informed (117, 119, 121) if both the grandparent node and parent node grant the time slot request to the requesting node. The invention works to reduce packet collisions by providing link-slot formulation in combination with link direction to compensate for spatial reuse loss in a local optimization setting.

### FIELD OF THE INVENTION

The present invention relates generally to wireless networking and more particularly to a time slot scheduling scheme in a multi-hop wireless network.

### BACKGROUND

In a multi-hop wireless network, voice and/or data traffic can be forwarded through a number of nodes between a source node and a destination node. Those skilled in the art will recognize that there are a number of multiple access control (MAC) protocols applicable to this type of system. Carrier Sensing Multiple Access/Collision Avoidance (CSMA/CA) described in the Institute of Electrical and Electronics Engineers (IEEE) 802.11 standard is one well-known MAC protocol for such a multi-hop wireless network.

When the CSMA/CA is used in a multi-hop wireless network, in order to avoid collisions between packet transmissions, each transmission transaction consists of a number of administrative commands to aid in collision avoidance. These administrative commands include a Request-to-send (RTS) command from the sender, a Clear-to-send (CTS) command from the receiver, a Data frame from the sender, and an Acknowledgment (ACK) from the receiver. Due to heavy overhead for each packet transmission, the capacity and network resource utilization in such a system is low.

Details of some embodiments of TDMA MAC in multi-hop wireless networks are described in U.S. Pat. No. 5,719,868 entitled “Dynamic distributed, multi-channel time division multiple access slot assignment method for a network of nodes,” issued on Feb. 17, 1998, and in United States Patent Application Publication No. 2003/0185166 entitled “Time division protocol for an ad-hoc, peer-to-peer radio network having coordinating channel access to shared parallel data channels with separate reservation channel,” filed on May 2, 2001 which are both herein incorporated by reference. In those proposed TDMA MAC schemes, the slot allocation is fully distributed and each node assigns the slot based on the slot utilization in its own “neighborhood.” The hidden node problem is not considered in the slot allocation process. Hence, the slot allocation is not collision free. Although the allocation adjustment can be used to resolve the conflicts in the initial slot assignment, the convergence is slow in such a process, and spatial reuse is not fully exploited; therefore, any improvement in capacity is limited.

Spatial Time Division Multiple Access (STDMA) is a conflict-free MAC protocol whereby links or nodes are scheduled to transmit in periodic time slots. Details of STDMA are described in a paper by Bjorklund et al. entitled “Resource Optimization of Spatial TDMA in Ad Hoc Radio networks: A Column Generation Approach;” IEEE Infocom 2003. In STDMA, several links or nodes can be assigned to transmit in the same time slot provided that their Multiple Access Interference allows simultaneous reception. Thus, the same time slot can be assigned to different nodes so long as the message destinations differ. In the Bjorklund et al. paper, two problem formulations have been studied for resource allocation with STDMA for wireless multi-hops networks: node-oriented and link-oriented allocation strategies.

In the node-oriented strategy, a node is assigned to one of several time slots. In each of these time slots, the node may send data to any neighboring nodes with link quality constrains. In order to avoid access collisions, the nodes close to a transmitting node are not allowed to transmit in the same time slot. This scheme is well-suited for broadcast traffic. In the link assignment strategy, a link is assigned one or more time slots for communications between a specific pair of nodes (Point-to-Point). Constraints for avoiding access collision are similar to the node-oriented strategy. Generally speaking, link assignment achieves a higher spatial reuse of the time slots, but is less suitable for broadcast traffic. Both problems in a network-wide scale are NP-hard in terms of computational complexity and assume a centralized scheduler available with needed global network information, which is very expensive to collect in a dynamic network.

Thus, for scheduling time slots in a spatial time division multiple access (SPTDMA) for a multi-hop wireless network, there are two current methods which can be used in the scheduling operation. These include the “global” approach like that defined in the IEEE 802.16 standard and at each individual node in the network. The global approach provides the best solution in terms of space reuse of the time slot, however, the computation and signaling costs are very high. The local approach is well distributed and requires less signaling, but this solution is less optimal and tends to lead to more network packet collisions.

### BRIEF DESCRIPTION OF THE FIGURES

The accompanying figures, wherein like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagram illustrating the transmission and reception of message traffic for spatial TDMA scheduling in accordance with an embodiment of the invention.

FIG. 2 is a block diagram illustrating a partial tree based spatial TDMA network as used in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to tree-based spatial TDMA scheduling for use in a multi-hop wireless network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions to perform tree-based spatial TDMA scheduling for use in a multi-hop wireless network described herein. The non-processor circuits may include, but are not limited to, a radio receiver, a radio transmitter, signal drivers, clock circuits, power source circuits, and user input devices. As such, these functions may be interpreted as steps of a method to perform tree-based spatial TDMA scheduling for use in a multi-hop wireless network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The present invention is directed to a method whereby a distributed scheme is used to reduce the computation burden and information cost in a multi-hop tree-based spatial TDMA wireless network. Moreover, the present invention works to maintain continuous connectivity with all nodes and an Internet Access Point (IAP) in a multi-hop wireless network as most of the application and network traffic is to/from one or more IAPs and the Internet. The invention further exploits existing network infrastructure to accelerate the TDMA tree construction process. As described herein, the invention includes at least four (4) features of a new TDMA slot scheduling scheme. These include: 1) local optimization where signal-to-noise ratio (SNR) constraints are replaced by neighboring nodes formulation; 2) Link-Slot formulations with additional link direction that work to compensate the spatial reuse loss in a local optimization setting; 3) utilization of hidden node constraints; and 4) use of a dead lock prevention and detection process.

As referred to herein, a “parent” node assigns a time slot to its “child” nodes. A node becomes a parent node when there is another node to choose to become the node's parent. A child node cannot assign a time slot to itself but must request a time slot from its parent node. However, a child node can operate both a child node and a parent node over its own children nodes. In operation, two or more nodes are related if they share the same parent node. A core family set includes one parent node plus its children nodes. Two core family sets in a family tree can be overlapped through a parent/child relationship. Therefore, two nodes are relatives of one another if they are in the same family tree but not in the same core family set. Two nodes may only be friend nodes if they are not in the same family tree but neighboring one another.

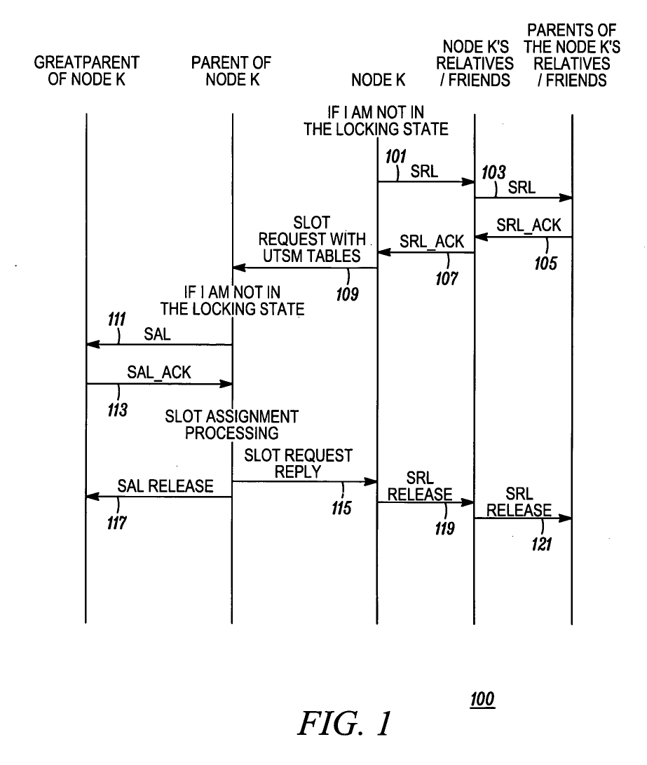

FIG. 1 is a diagram illustrating communications 100 between various nodes in a typical mesh network. Those skilled in the art will recognize that each node in the network maintains a usage of time slot map (UTSM) table that records the slots. Each slot is marked as a receiving slot or a sending slot to improve the spatial reuse in the future slot allocation. In operation, each node in the network broadcasts a “hello/beacon” message that includes its UTSM table. Each node discovers its one hop neighbor by receiving the “hello/beacon” message where it records the neighbor's address and neighbor's UTSM table in its neighbor table. Each “parent” node in the network also maintains an allocation of time slot map (ATSM) so to record the slots assigned to its child nodes.

In the mesh network described herein, nodes over several layers may more easily be described using a parent, child, grandchild terminology just as in a family tree. In the proposed invention, the Internet Access Point (IAP) is the root and first parent node on the tree. When sending a packet communication, a node always elects another node closer to the IAP as its parent node, and the election can be based on a metric if it can see multiple upstream nodes (closer to the IAP). As referred to herein, a “parent” node assigns a time slot to its “child” nodes. A node becomes a parent node when there is another node to choose it to become the node's parent. A child node cannot assign a time slot to itself but must request a time slot from its parent node. However, a child node can operate both a child node and a parent node over its own children nodes. In operation, two or more nodes are related if they share the same parent node. A core family set includes one parent node plus its children nodes. Two core family sets in a family tree can be overlapped through a parent/child relationship. Hence, two nodes are relatives of one another if they are in the same family tree but not in the same core family set. Two nodes may only be friend nodes if they are not in the same family tree but neighboring one another.

Thus, two neighboring nodes are “brother” nodes if they are sharing same parent node. Two neighboring nodes are “relative” nodes if they are sharing one grandparent node or on the same family tree. Two neighboring nodes are “friend” nodes if they are not sharing any parent node or are not on the same family tree. In the network as described herein, a uni-casting time slot will include one sending node and one receiving node. If a slot is used for multi-casting or broadcasting, there will be multiple receiving nodes and a single sending node. When a node requests time slots from its parent, it will inform its intended destination node or nodes. For each node, a neighboring node set is maintained that includes a one-hope neighboring node set. Five possible types of neighboring node set memberships are present and include parent, child, brother relative and friend. Each parent node maintains an Allocation Time Slot map (ATSM) for its own. An assignment of a time slot from a parent to child node is based on the ATSM and other information. Each node also maintains a usage time slot map (UTSM) and records all the time slots in which this node is either a source or a destination node. Multi-casting time slots from other neighboring nodes will be included as a receiving time slot. Finally, a TDMA tree is one whose root node is a parent node and any intermediate nodes are both parent and child nodes.

Turning now to FIG. 1, if it is assumed that a node K needs a new time slot, before initiating any request process, node K will first determine whether it is locked by any other nodes. If the node is not locked, it first locks its one and two hop neighbors. Node K will then send out a slot request locking (SRL) message 101 to all its relative and friend nodes. Upon receiving the SRL, the relative/friend node forwards the SRL 103 to its own parent node. Upon receiving the forwarded SRL, the parent node of the relative/friend node acknowledges (ACK) the SRL 105 back to the forwarding node, and stops any new time slot assignment during the lock period.

Upon receiving the acknowledgment, the relative/friend node forwards the ACK 107 to requesting node K. After receiving all the SRL acknowledgments, node K then starts the request process and will send out a time slot request 109 to its parent, and the request carries the UTSM tables of its relative and friend nodes. If the parent node is not locked by other SRL or slot assignment lock (SAL) message, it will send SAL 111 to its own parent (the node's grandparent) to lock its own parent from assigning slots. The grandparent node then sends back acknowledgment 113 to the parent node. After receiving the acknowledgment message, the parent node will process the assignment algorithm by doing appropriate operations on its own ATSM table and UTSM tables received from the node. The UTSM tables received from the node reflect the slot occupancy in the node's neighborhood. Thus, the ATSM table reflects a partial “global” view of this neighborhood, which has an optimized slot allocation by utilizing both the distributed information and partial global information.

After performing an assignment algorithm (not shown), the parent node informs the requesting node of the assignment result 115, and subsequently updates its ATSM table to reflect the new slot assignment. Meanwhile, the parent node sends out an unlocking SRL message to its parent to unlock the slot assignment lock. Upon receiving the assignment result, node K will unlock its one hop and two hop neighbors which were locked before the assignment. The node sends out unlocking SRL messages 119, 121 to nodes to which it sent out the SRL message before the assignment. Thus, similar to passing the SRL message, the node receiving the unlocking SRL will forward it to its own parent so that the one and two hop neighbors are free to start a new slot assignment process. The requesting node then updates its own UTSM table to reflect the new assignment and distributes the UTSM table through the hello/beacon message to its one hop neighbors.

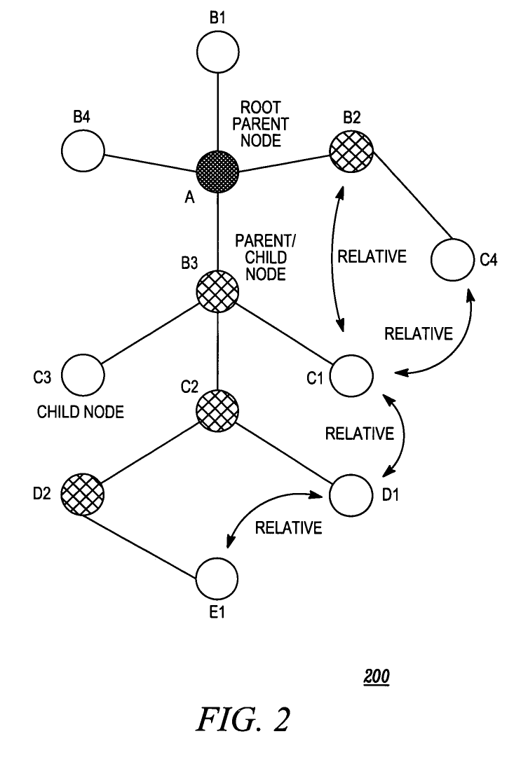

As an example in implementing the new method for tree-based TDMA scheduling, FIG. 2 is a block diagram illustrating a partial mesh network 200 having layers A, B, C, D and E with associated nodes therein. In the illustration, node C1 has five one hop neighboring nodes namely nodes B2, B3, C2, C4, D1. Node B3 is node C1's parent node which is closer to the root node. Note that node B3 may have more optimal metrics than C1's other upstream nodes so its appointed as the parent node of C1. Node C2 is node C1's brother node since they share the same parent node. Nodes B2, C4 and D1 are C1's relative nodes. Since nodes C1 and C4 have the same grandparent, node B2's parent is C1's grandparent, and D1's grandparent is C1's parent.

If we are to suppose that node C1 wishes to request a new time slot for transmitting message traffic to its brother node C2, then node C1 first determines that it is not in the SRL and SAL period. If node C1 is not locked, it will first lock its one and two hop neighbors where node C1 sends out SRL messages to its three relative nodes namely nodes B2, C4 and D1. After receiving the SRL, node B2 forwards the SRL to its parent node A, C4 forwards the SRL to its parent B2, and D1 forwards the SRL to its parent node C2. Upon receiving the SRL, nodes A, B2 and C2 send acknowledgment messages back to nodes B2, C4, and D1, respectively. Nodes B2, C4 and D1 further forward the acknowledgments back to node C1.

After receiving the positive SRL acknowledgments from its neighbors, node C1 initiates the request process where it will propose a time slot assignment request to its parent node B3 with UTMS tables of nodes B2, C4 and D1. If node B3 is not SRL and SAL locked, it will first lock its own parent node A where node B3 sends a SAL message to node A. Node A will then reply with an acknowledgment to node B3. After getting the positive acknowledgment from node A, node B3 then fulfills the slot assignment request based on some optimal assignment algorithm. Node B3 will transmit back the slot assignment result to node C1, and meanwhile unlocks its parent node A. Node B3 will also update its ATSM to reflect the slot assignment. After getting the assignment, node C1 unlocks its one hop and two hop relative/friend nodes and node C1 sends an unlock SRL to nodes B2, C4 and D1. Thereafter, nodes B2, C4 and D1 forward the unlock message to their parent nodes A, B2 and C2, respectively. After receiving the new assignment, node C1 updates its UTSM table to reflect the slot usage, and distributes its new UTSM table in its hello/beacon message to its one hop neighbors.

Thus, when any node in the network moves to new neighborhood, it will build new neighboring relationships by listening to the hello/beacon messages from its neighbors and will then elect a new parent node based on one or more metrics. These metrics might include link quality, number of hops to the root node, etc. The node then collects the UTSM tables from its new neighboring nodes by checking received hello/beacon messages. Once the node sets up a new neighboring relationship, it will confirm with its new parent about the slot allocation in the same process as described before

Thus, the method for tree based TDMA scheduling in a mesh wireless network includes several unique features which essentially provide a link-slot formulation in combination with link direction to compensate the spatial reuse loss in a local optimization setting. This combination operates to consider hidden node constraints where a time slot assignment race in a prevention method reduces the probability of packet conflicts and collisions. Dead lock prevention and detection are also provided using a local optimization. Any SNR constraints are replaced by the neighboring node formulation process. The invention is applicable to IEEE 802.15 and 802.16 meshing standards since these are TDMA based systems; however, the present invention is more bandwidth efficient than these standards using present multi-hop slot allocation algorithms because they do not consider the spatial reuse.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for time slot scheduling in a wireless time division multiple access (TDMA) mesh network based on spatial orientation of the network nodes, comprising the steps of:
establishing a network topology having at least a grandparent node at a grandparent layer, a parent node at a parent layer and a time slot requesting node at a requesting layer;
requesting non-use of a requested time slot by a requesting node at the requesting layer to all neighboring nodes at the requesting layer;
requesting non-use of the requested time slot from the requesting node at the requesting layer to its parent node at the parent layer;
requesting a time slot assignment from the requesting node at the requesting layer to its parent node at the parent layer;
requesting a time slot assignment from the parent node to the grandparent node of the requesting node; and
informing all neighboring nodes if the grandparent node and parent node grant the time slot request to the requesting node.

2. A method for time slot scheduling in a wireless TDMA mesh network, as in claim 1 wherein the grandparent layer, parent layer and requesting layer in the network are each at differing hierarchical levels.

3. A method for time slot scheduling in a wireless TDMA mesh network, as in claim 1, wherein the neighboring nodes reply to the request for non-use with an acknowledgment.

4. A method for time slot scheduling in a wireless TDMA mesh network, as in claim 1, wherein the parent nodes of the neighboring nodes reply to the neighboring nodes with an acknowledgment.

5. A method for time slot scheduling in a wireless TDMA mesh network, as in claim 1, further comprising the step of:
granting a time slot request if no time slot conflict is recognized by the grandparent node and parent node of the requesting node.

6. A method for time slot scheduling in a wireless TDMA mesh network, as in claim 1, wherein the step of requesting a time slot assignment from the requesting node includes data regarding time slot usage.

7. A method for scheduling time slots in a time division multiple access (TDMA) mesh network based on spatial location of nodes associated with a time slot requesting node, comprising the steps of:
establishing a plurality of hierarchical levels for the nodes in the mesh network including at least a grandparent level; parent level and a requesting level;
sending a request to lock message from the requesting node at the request level to its neighboring nodes at the requesting level for communicating that a time slot should not be used for a predetermined time period;
sending a request to lock message from at least one neighboring node to its parent node for communicating that a time slot should not be used for a predetermined time period;
sending a time slot request message from the requesting node to its parent node for requesting use of the time slot;
sending a time slot request message from the requesting node's parent node to the requesting node's grandparent node for requesting use of the time slot; and
sending a release message for releasing the requested time slot to the requesting node if available.

8. A method for scheduling time slots in a TDMA mesh network as in claim 7, further including the step of:
sending a time slot release message to all neighboring nodes and the parent of the neighboring nodes indicating the time slot has been released to the requesting node.

9. A method for scheduling time slots in a TDMA mesh network as in claim 7, wherein the step of sending a time slot request message to the parent node includes the step of:
sending data regarding time slot availability along with the time slot request message.

10. A method for scheduling time slots in a TDMA mesh network as in claim 7, wherein the neighboring nodes and the parents of the neighboring nodes send an acknowledgment message acknowledging the receipt of the request to lock message.

11. A method for scheduling time slots in a TDMA mesh network as in claim 7, wherein the parent node grandparent node of the requesting node send an acknowledgment message acknowledging receipt of the time slot request message.

12. A method for scheduling time slots in a TDMA mesh network as in claim 7, wherein the time slot release message is sent from the requesting node to the neighboring nodes.

13. A time division multiple access (TDMA) spatial scheduling method for use with mesh multi-hop wireless network comprising the steps of:
establishing a multi-level mesh network whereby a requesting node is associated with at least a parent node and grandparent node at differing hierarchical levels;
sending a lock message from a requesting node to neighboring nodes at the same hierarchical level for requesting non-use of a time slot by the requesting node;
sending a lock message from the neighboring nodes to their parent nodes for requesting non-use of the time slot;
sending a request message from the requesting node to its parent node for requesting the assignment of the time slot to the requesting node;
sending a request message from the parent node of the requesting node to the grandparent node of the requesting node for requesting the assignment of the time slot to the requesting node; and
releasing the time slot from the grandparent node and the parent node to the requesting node if available.

14. A TDMA spatial scheduling method as in claim 13, wherein the step of releasing the time slot includes the steps of:
sending a release message from the requesting node to the neighboring nodes to communicate the release of the time slot; and
sending a release message from the neighboring node to its parent nodes for communicating the release of the time slot.

15. A TDMA spatial scheduling method as in claim 13, further including the step of:
sending an acknowledgment message by the neighboring nodes in reply to the lock message.

16. A TDMA spatial scheduling method as in claim 13, further including the step of:
sending an acknowledgment message by the parent node of the neighboring nodes in reply to the lock message.

17. A TDMA spatial scheduling method as in claim 13, further including the step of:
sending an acknowledgment message by the parent node of the requesting node in reply to the request message.

18. A TDMA spatial scheduling method as in claim 13, further including the step of:
sending an acknowledgment message by the grandparent node of the requesting node in reply to the request message by the parent node.

19. A TDMA spatial scheduling method as in claim 13, further including the step of:
providing time slot usage data with the request message.
